(19) United States
(12) Patent Application Publication
(10) Pub. No.: US 2018/0111815 A1
(43) Pub. Date: Apr. 26, 2018

(54) BEVERAGE DISPENSING VALVE AND NOZZLE

(71) Applicant: Dispenser Beverages Inc., Orlando, FL (US)

(72) Inventor: ROBERT SCOTT RIEL, Winter Garden, FL (US)

(73) Assignee: Dispenser Beverages Inc., Orlando, FL (US)

(21) Appl. No.: 15/431,864

(22) Filed: Feb. 14, 2017

Related U.S. Application Data
(63) Continuation of application No. 15/334,438, filed on Oct. 26, 2016.

(51) Int. Cl. B67D 1/00

(52) U.S. Cl. CPC B67D 1/0046; B67D 1/0081; B67D 1/0021

(57) ABSTRACT

A beverage dispensing nozzle is provided. The beverage dispensing nozzle may include an upper portion configured to receive juice concentrate, a lower portion coupled to the upper portion and configured to receive juice concentrate from the upper portion, an agitation device configured to mix the juice concentrate and a liquid within the lower portion, and a nozzle output configured to output a mixture of the juice concentrate and the liquid mixed by the agitation device. At least one of the upper portion and lower portion may include an umbrella valve configured to regulate flow of the juice concentrate.

### CROSS-REFERENCE TO RELATED APPLICATION

This application is a continuation of, and claims the benefit of, U.S. patent application Ser. No. 15/334,438, filed on Oct. 26, 2016, which is incorporated herein by reference in its entirety.

### TECHNICAL FIELD

The present disclosure generally relates to a beverage dispensing valve and nozzle, and more particularly to a valve and nozzle for reconstituting and dispensing juice and drink concentrates.

### SUMMARY

In the juice dispensing industry, many juices are packaged in concentrate form and then are mixed with water just prior to dispensing. Mixing the juice concentrate and the water may occur within a nozzle that dispenses the juice. However, the juice concentrate may not fully mix with the water, which may result in a juice that does not have a uniform consistency. Moreover, because the juice concentrate contains pulp, or particles of the fruit and/or vegetable from which the concentrate originates, the nozzle may become clogged by the pulp of the juice concentrate.

In addition, there are numerous juice manufacturers that sell juice concentrate in a variety of different concentrate bottles. Each of the concentrate bottles requires a nozzle that can be coupled to the bottle in a manner that seals the bottle during shipping, but mixes and dispenses the juice. However, a nozzle that works with one concentrate bottle may not work with a different concentrate bottle. So if a customer has a dispensing machine with a particular type of nozzle that only operates with a particular type of bottle, the customer may not be able to purchase juice concentrate in a different type of bottle, without also purchasing a new nozzle that can be coupled to the different type of bottle.

Thus, there is a need for a juice dispensing nozzle that can accommodate different juice concentrate bottles, and that provides increased juice consistency without clogging.

According to an aspect of one or more exemplary embodiments of the present disclosure, there is provided a beverage dispensing nozzle that may include an upper portion configured to receive juice concentrate, a lower portion coupled to the upper portion and configured to receive juice concentrate from the upper portion, an agitation device configured to mix the juice concentrate and a liquid within the lower portion, and a nozzle output configured to output a mixture of the juice concentrate and the liquid mixed by the agitation device. At least one of the upper portion and lower portion may include an umbrella valve configured to regulate flow of the juice concentrate.

The upper portion may include an upper umbrella valve, and the lower portion may include a lower umbrella valve. The beverage dispensing nozzle may include a liquid inlet configured to provide the liquid that is mixed by the agitation device within the lower portion. The agitation device may include an upper agitator configured to mix the juice concentrate and the liquid, and a lower agitator configured to receive the mixture of juice concentrate and the liquid from the upper agitator, and further mix the juice concentrate and the liquid. The upper agitator may include a first plurality of protrusions configured to mix the juice concentrate and liquid, and one or more outlets configured to output the mixture of juice concentrate and the liquid. The lower agitator may include a second plurality of protrusions configured to mix the mixture of juice concentrate and the liquid. The first plurality of protrusions may extend radially outward from a center of the upper agitator. The one or more outlets of the upper agitator may be disposed around an outer periphery of the upper agitator. Alternatively, the one or more outlets may be disposed in a star-shaped configuration. The upper agitator may be conically-shaped.

The upper portion may also include at least one upper opening configured to output the juice concentrate to the lower portion, and an upper hole configured to couple the upper umbrella valve to the upper portion. The at least one upper opening may include two upper semi-circular openings that substantially surround the upper hole. The upper umbrella valve may include a stem that is configured to be coupled to the upper hole to couple the upper umbrella valve to the upper portion.

The lower portion may include at least one lower opening configured to output the juice concentrate to the agitation device, and a lower hole configured to couple the lower umbrella valve to the lower portion. The at least one lower opening may include two lower semi-circular openings that substantially surround the lower hole. The lower umbrella valve may include a stem that is configured to be coupled to the lower hole to couple the lower umbrella valve to the lower portion.

### BRIEF DESCRIPTION OF DRAWINGS

FIG. 1 is a lateral view of a beverage dispensing nozzle according to an exemplary embodiment.

FIG. 2 is an elevated lateral view of the beverage dispensing nozzle according to the exemplary embodiment of FIG. 1.

FIG. 3 is an elevated lateral view of the beverage dispensing nozzle according to the exemplary embodiment of FIGS. 1 and 2.

FIG. 4 is an elevated cross-sectional view of the beverage dispensing nozzle according to the exemplary embodiment of FIGS. 1-3.

FIG. 5a includes a lateral cross-sectional view and a top view of a beverage dispensing nozzle according to an exemplary embodiment.

FIG. 5b includes a lateral cross-sectional view and a top view of a beverage dispensing nozzle according to an exemplary embodiment.

### DETAILED DESCRIPTION OF EXEMPLARY EMBODIMENTS

Reference will now be made in detail to the following exemplary embodiments, which are illustrated in the accompanying drawings, wherein like reference numerals refer to like elements throughout. The exemplary embodiments may be embodied in various forms without being limited to the exemplary embodiments set forth herein. Descriptions of well-known parts are omitted for clarity.

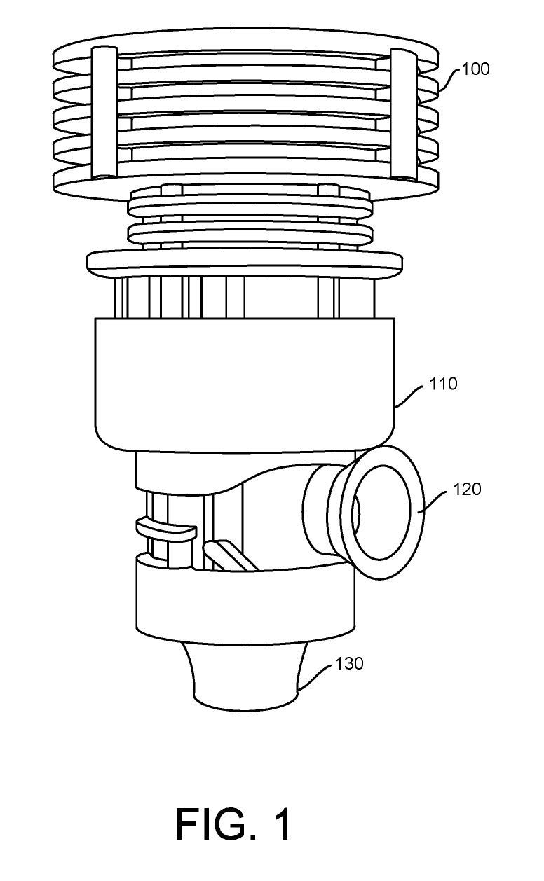

FIG. 1 is a lateral view of a beverage dispensing nozzle according to an exemplary embodiment. Referring to FIG. 1, the beverage dispensing nozzle of the exemplary embodiment may include an upper portion 100 that is configured to be coupled to a juice concentrate bottle and receive juice concentrate. The beverage dispensing nozzle of the exemplary embodiment may also include a lower portion 110 and a water inlet 120. The lower portion 110 may be configured to receive juice concentrate after it passes through the upper portion 100. The lower portion 110 may be movably coupled to the upper portion 100 so that the lower portion 110 is configured to move up and down with respect to the upper portion 100 in order to create a vacuum that forces the juice concentrate to pass through the upper portion 100 into the lower portion 110. The water inlet 120 may be configured to receive water from a water supply source that may be mixed with the juice concentrate in the lower portion 110. Although the current exemplary embodiment describes a water inlet 120 that receives water to mix with the juice concentrate, the exemplary embodiment is not limited to receiving water, and may receive other liquids to mix with the juice concentrate. The beverage dispensing nozzle of the exemplary embodiment of FIG. 1 may also include an outlet 130 that outputs the juice after the juice concentrate has been mixed with the water or other liquid received from the water inlet 120.

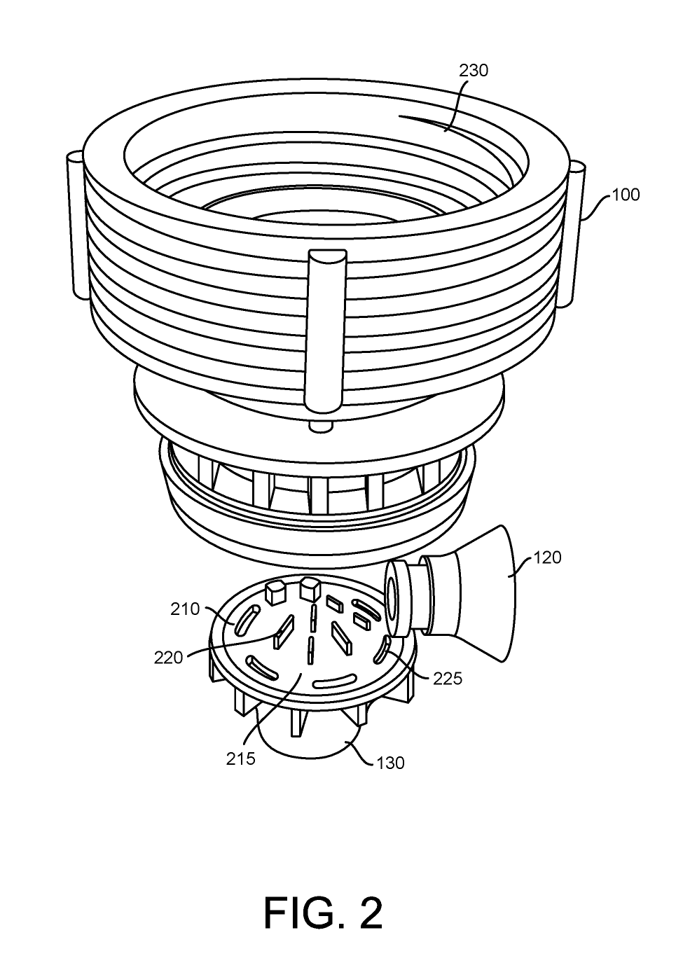

FIG. 2 shows an elevated lateral view of the beverage dispensing nozzle according to the exemplary embodiment of FIG. 1, wherein the lower portion 110 has been removed. Referring to FIG. 2, the beverage dispensing nozzle according to the current exemplary embodiment may include an upper agitator 210 that is configured to mix the juice concentrate received from the upper portion 100 with the water or other liquid received from the water inlet 120. The upper agitator 210 may be disposed on the outlet 130. The upper agitator 210 may include a base portion 215, upon which protrusions 220 may be disposed. The base portion 215 may be located in a center part of the upper agitator 210, and may be conically-shaped so that the center of the base portion 215 is located closer to the upper opening of the upper portion 100 than the periphery of the base portion 215.

The base portion 215 may include a plurality of protrusions 220 that may extend perpendicularly from the base portion 215. The protrusions 220 shown in the exemplary embodiment of FIG. 2 may have a rectangular cross-section, however the exemplary is not limited thereto and may include protrusions 220 having alternative cross-sections, such as, without limitation, square, circular, or triangular cross-sections. The protrusions 220 shown in the exemplary embodiment of FIG. 2 extend radially outward from the center of the base portion 215, but may also be arranged in any other configuration on the base portion 215.

The upper agitator may also include output slots 225 that may be located around a periphery of the base portion 215. The output slots 225 of the exemplary embodiment of FIG. 2 are elongated, however output slots 225 may have alternative shapes. In operation, the juice concentrate may pass through the upper portion 100 and enter the lower portion 110. The water or other liquid may enter the lower portion 110 via the water inlet 120. As the juice concentrate and the water or liquid come into contact with the protrusions 220 and base portion 215, the juice concentrate mixes with the water or other liquid. After the juice concentrate has mixed with the water or other liquid, the juice passes through the output slots 225 to enter the output 130.

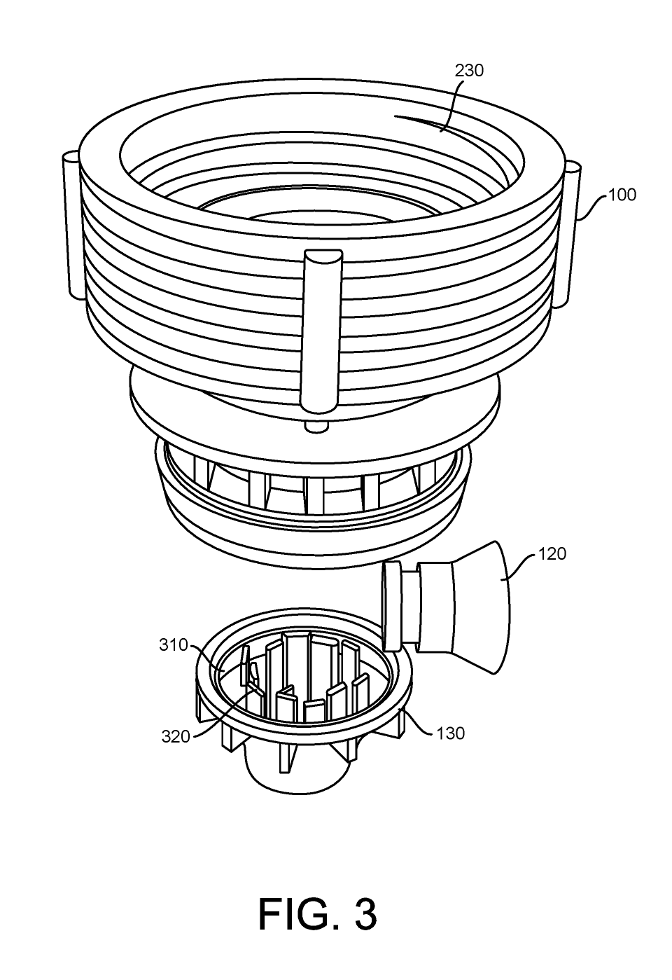

FIG. 3 shows an elevated lateral view of the beverage dispensing nozzle according to the exemplary embodiment of FIGS. 1 and 2, wherein the upper agitator 210 has been removed to show the nozzle 130 in more detail. Referring to FIG. 3, the beverage dispensing nozzle according to the current exemplary embodiment may include a lower agitator 310 that is configured to further mix the juice after it has been mixed by, and passed through, the upper agitator 210. The lower agitator 310 may include additional protrusions 320 that may extend vertically from the bottom of the outlet 130. Although the protrusions 320 in FIG. 3 are vertically elongated, the protrusions 320 may be in the form of other shapes and/or orientations. In operation, the juice is output from output slots 225 of upper agitator 210, and comes into contact with additional protrusions 320. The engagement of the juice with the additional protrusions 320 causes the juice to mix further, before it is output from the bottom end of outlet 130.

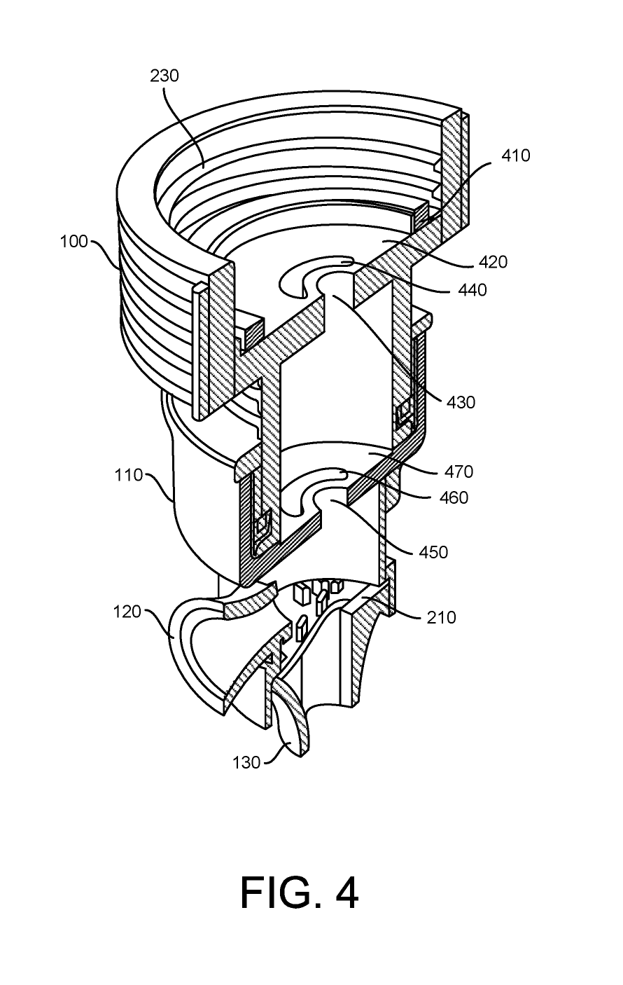

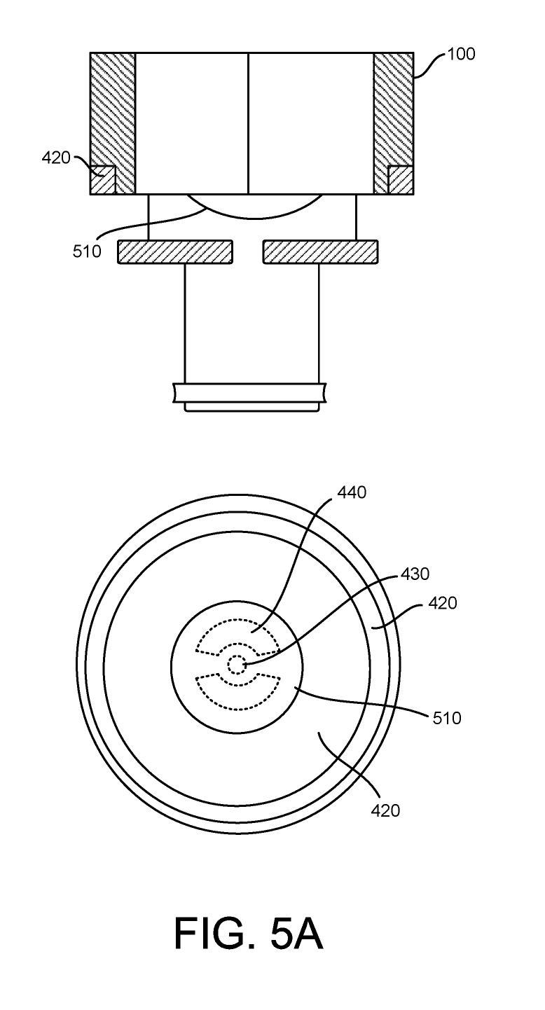

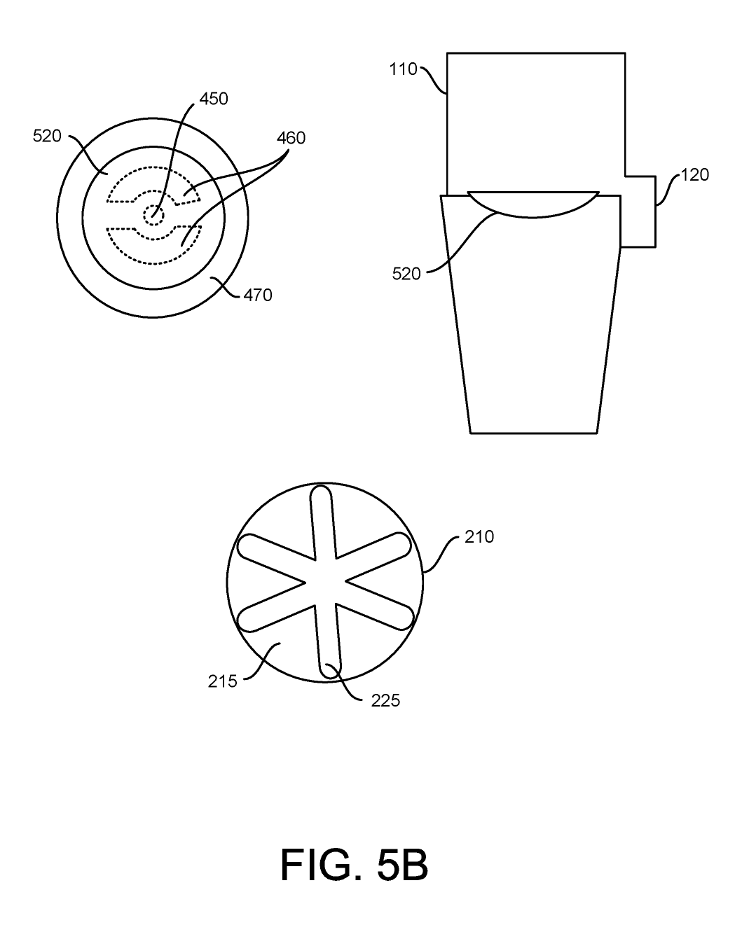

FIG. 4 shows an elevated cross-sectional view of the beverage dispensing nozzle according to the exemplary embodiment of FIGS. 1-3. The components of the exemplary embodiment that were explained above will not be repeated here to avoid redundancy. Referring to FIG. 4, the beverage dispensing nozzle according to the current exemplary embodiment may include an o-ring 410 that may be disposed along an inner periphery of upper portion 100. The upper portion 100 may also include an upper base plate 420 that covers the inner cross-sectional area of the upper portion 100. Near the center of the upper base plate 420, there may be an upper hole 430 that is configured to allow juice concentrate to pass through the upper base plate 420. The upper base plate 420 may also include two upper semi-circular openings 440 that may substantially surround the upper hole 430, and are configured to allow additional juice concentrate to pass through the upper base plate 420. An umbrella valve (shown in FIG. 5) may be disposed under the upper base plate 420 so that it covers the upper hole 430 and the upper semi-circular openings 440. The umbrella valve may operate to regulate the flow of juice concentrate through the upper hole 430 and upper semi-circular openings 440. The umbrella valve may be an elastomeric valve component that has a diaphragm-shaped sealing disk or umbrella shape. The umbrella valve is used as a sealing element to prevent backflow of juice concentrate into the upper portion 100. The umbrella valve also creates a seal that prevents leaking of juice concentrate during shipping. In the exemplary embodiment of FIG. 4, the upper semi-circular openings 440 are not connected to each other, however the exemplary embodiment is not limited to this configuration. For example, the upper semi-circular openings 440 may be connected so as to form a continuous circular opening surrounding the upper hole 430.

With continued reference to FIG. 4, in the beverage dispensing nozzle according to the current exemplary embodiment, the lower portion 110 may include a lower base plate 470 that covers the inner cross-sectional area of the lower portion 110. Near the center of the lower base plate 470, there may be a lower hole 450 that is configured to allow juice concentrate to pass through the lower base plate 470. The lower base plate 470 may also include two lower semi-circular openings 460 that may substantially surround the lower hole 450, and are configured to allow additional juice concentrate to pass through the lower base plate 470. An umbrella valve (shown in FIG. 5) may be disposed under the lower base plate 470 so that it covers the lower hole 450 and the lower semi-circular openings 460. The umbrella valve may operate to regulate the flow of juice concentrate through the lower hole 450 and the lower semi-circular openings 460. In the exemplary embodiment of FIG. 4, the lower semi-circular openings 460 are not connected to each other, however the exemplary embodiment is not limited to this configuration. For example, the lower semi-circular openings 460 may be connected so as to form a continuous circular opening surrounding the lower hole 450.

FIG. 5A shows a lateral cross-sectional view and a top view of the upper portion 100 of a beverage dispensing nozzle according to an exemplary embodiment. Referring to FIG. 5A, the beverage dispensing nozzle according to the exemplary embodiment may include an upper portion 100, which may include an o-ring disposed along an inner periphery of the upper portion 100. The upper portion 100 may include an upper base plate 420, upper hole 430, and upper semi-circular openings 440, as described above. As shown in the cross-section view of FIG. 5A, the upper portion 100 may include an upper umbrella valve 510 that may be coupled to the bottom side of the upper base plate 420 and may encompass both the upper hole 430 and the upper semi-circular openings 440. The upper umbrella valve 510 may be concave when viewed from the top of the upper portion 100. The upper umbrella valve 510 may include a stem that may have one end coupled to the upper umbrella valve 510 and a second end that extends through the upper hole 430 to secure the upper umbrella valve 510 to the bottom side of the upper base plate 420.

FIG. 5B shows a lateral cross-sectional view and a top view of the lower portion 110 of a beverage dispensing nozzle according to an exemplary embodiment. Referring to FIG. 5B, the beverage dispensing nozzle according to the exemplary embodiment may include a lower portion 110, which may include a lower base plate 470, lower hole 450, and lower semi-circular openings 460, as described above. The lower portion 110 may also include a lower umbrella valve 520 that may be coupled to the bottom side of the lower base plate 470, and may encompass both the lower hole 450 and the lower semi-circular openings 460. The lower umbrella valve 520 may be concave when viewed from the top of the lower portion 110. The lower umbrella valve 520 may include a stem that may have one end coupled to the lower umbrella valve 520 and a second end that extends through the lower hole 450 to secure the lower umbrella valve 520 to the bottom side of the lower base plate 470.

With further reference to FIG. 5b, an alternative exemplary embodiment of the upper agitator 210 is shown. Unlike the exemplary embodiment shown in FIG. 2, in which the upper agitator 210 included output slots 225 around the periphery of base portion 215, the output slots 225 may be arranged in a star configuration on the base portion 215. In this exemplary embodiment, the protrusions 220 may be disposed on the base portion 215 in between the output slots 225.

Although the inventive concepts of the present disclosure have been described and illustrated with respect to exemplary embodiments thereof, it is not limited to the exemplary embodiments disclosed herein and modifications may be made therein without departing from the scope of the inventive concepts.

1. A beverage dispensing nozzle comprising:
an upper portion configured to receive juice concentrate;
a lower portion coupled to the upper portion and configured to receive juice concentrate from the upper portion;
an agitation device configured to mix the juice concentrate and a liquid within the lower portion; and
a nozzle output configured to output a mixture of the juice concentrate and the liquid mixed by the agitation device;
wherein at least one of the upper portion and lower portion comprises an umbrella valve configured to regulate flow of the juice concentrate; and
wherein the agitation device comprises:
an upper agitator configured to mix the juice concentrate and the liquid; and
a lower agitator configured to receive the mixture of juice concentrate and the liquid from the upper agitator, and further mix the juice concentrate and the liquid.

2. The beverage dispensing nozzle of claim 1, wherein the upper portion comprises an upper umbrella valve, and the lower portion comprises a lower umbrella valve.

3. The beverage dispensing nozzle of claim 1 further comprising:
a liquid inlet configured to provide the liquid that is mixed by the agitation device within the lower portion.

4. (canceled)

5. The beverage dispensing nozzle of claim 1, wherein the upper agitator comprises:
a first plurality of protrusions configured to mix the juice concentrate and liquid; and
one or more outlets configured to output the mixture of juice concentrate and the liquid.

6. The beverage dispensing nozzle of claim 5, wherein the lower agitator comprises a second plurality of protrusions configured to mix the mixture of juice concentrate and the liquid.

7. The beverage dispensing nozzle of claim 5, wherein the first plurality of protrusions extend radially outward from a center of the upper agitator.

8. The beverage dispensing nozzle of claim 7, wherein the one or more outlets are disposed around an outer periphery of the upper agitator.

9. The beverage dispensing nozzle of claim 7, wherein the one or more outlets are disposed in a star-shaped configuration.

10. The beverage dispensing nozzle of claim 1, wherein the upper agitator is conically-shaped.

11. The beverage dispensing nozzle of claim 2, wherein the upper portion comprises:
at least one upper opening configured to output the juice concentrate to the lower portion; and
an upper hole configured to couple the upper umbrella valve to the upper portion.

12. The beverage dispensing nozzle of claim 11, wherein the at least one upper opening comprises two upper semi-circular openings that substantially surround the upper hole.

13. The beverage dispensing nozzle of claim 11, wherein the upper umbrella valve comprises a stem that is configured to be coupled to the upper hole to couple the upper umbrella valve to the upper portion.

14. The beverage dispensing nozzle of claim 11, wherein the lower portion comprises:
at least one lower opening configured to output the juice concentrate to the agitation device; and
a lower hole configured to couple the lower umbrella valve to the lower portion.

15. The beverage dispensing nozzle of claim 14, wherein the at least one lower opening comprises two lower semi-circular openings that substantially surround the lower hole.

16. The beverage dispensing nozzle of claim 14, wherein the lower umbrella valve comprises a stem that is configured to be coupled to the lower hole to couple the lower umbrella valve to the lower portion.
